(19) United States
(12) Patent Application Publication
(10) Pub. No.: US 2012/0235480 A1
(43) Pub. Date: Sep. 20, 2012

(54) UNINTERRUPTED POWER SUPPLY SYSTEM AND UNINTERRUPTED POWER SUPPLY DEVICE

(75) Inventor: Hyuk Kim, Seoul (KR)

(73) Assignee: JUHA CO., LTD., Seoul (KR)

(21) Appl. No.: 13/512,831

(22) PCT Filed: Nov. 3, 2010
(86) PCT No.: PCT/KR10/07714

§ 371 Date: May 30, 2012

(30) Foreign Application Priority Data
Nov. 30, 2009 (KR) KR10-2009-0116749

(51) Int. Cl. H02J 7/34

(52) U.S. Cl. 307/18

(57) ABSTRACT

An uninterruptible power supply (UPS) system includes a plurality of UPS devices configured to provide a single-phase AC input voltage to a load and a battery when an operating mode is a normal mode and configured to convert power of the battery into a single-phase AC output voltage to provide the single-phase AC output voltage to the load when the operation mode is a blackout mode. Each of the plurality of the UPS devices commonly receives the single-phase AC input voltage to commonly output the single-phase AC output voltage when a configuration mode is a single-phase parallel mode. At least three UPS devices independently receive each of a three-phase AC input voltage to output each of a three-phase AC output voltage when the configuration mode is a three-phase mode.

### CROSS-REFERENCE TO RELATED APPLICATIONS

This application is the United States National Phase under 35 U.S.C. §371 of PCT International Patent Application No. PCT/KR2010/007714, which designated the United States of America, having an International Filing date of Nov. 3, 2010, and claiming priority to Korean Application No. 10-2009-0116749, filed Nov. 30, 2009.

### BACKGROUND OF THE INVENTION

1. Field of the Invention

The present invention relates to a power supplying technology and more particularly, to an uninterruptible power supply system and uninterruptible power supply device.

2. Description of the Related Art

In general, an uninterruptible power supply (UPS) is used in an emergency such as a power failure for providing auxiliary power such as a battery to a load. The UPS operates in the emergency to provide the auxiliary power, and protects electrical devices to safely terminate.

In general, the UPS is not restricted to a computer protection device, and is used against damages, business interruption or data loss due to unexpected power interruption in a data center, a communication device or other electrical device.

### SUMMARY OF THE INVENTION

In some embodiments, an uninterruptible power supply (UPS) system includes a plurality of UPS devices configured to provide a single-phase AC input voltage to a load and a battery when an operating mode is a normal mode, and configured to convert power of the battery into a single-phase AC output voltage to provide the single-phase AC output voltage to the load when the operation mode is a blackout mode. Each of the plurality of the UPS devices commonly receives the single-phase AC input voltage to commonly output the single-phase AC output voltage when a configuration mode is a single-phase parallel mode. At least three UPS devices independently receive each of a three-phase AC input voltage to output each of a three-phase AC output voltage when the configuration mode is a three-phase mode.

In some embodiments, an uninterruptible power supply (UPS) device includes a first transforming circuit configured to commonly receive a single-phase AC input voltage with a separate single-phase UPS device to transmit the received single-phase AC input voltage to a battery when a configuration mode is a single-phase parallel mode and configured to receive a phase voltage of three-phase AC input voltage to transmit the received phase voltage to the battery when the configuration mode is a three-phase mode, a second transforming circuit configured to transform a power of the battery into a single-phase AC output voltage to commonly output the converted single-phase AC output voltage with the separate single-phase UPS device when the configuration mode is the single-phase parallel mode and configured to transform the power of the battery into a three-phase AC output voltage to output the converted three phase AC output voltage when the configuration mode is the three-phase mode, and a control unit including a setting unit and a processor, the setting unit setting the configuration mode and a parameter according to the configuration mode and the processor controlling an operation mode of the first and second transforming circuits based on the configuration mode and the parameter.

### BRIEF DESCRIPTION OF THE DRAWINGS

FIG. 1 is a block diagram illustrating an uninterruptible power supply.

FIG. 2 illustrates a UPS system 1000A when a configuration mode is a single-phase parallel mode.

FIG. 3 illustrates a UPS system 1000B when a configuration mode is a three phase mode.

FIG. 4 is a block diagram illustrating a UPS device according to an example embodiment of the present invention.

FIG. 5 is a block diagram illustrating a control unit included in an uninterruptible power supply device in FIG. 4.

### DETAILED DESCRIPTION OF THE INVENTION

Reference will now be made in greater detail to a preferred embodiment of the invention, an example of which is illustrated by the accompanying drawings.

Since descriptions of the disclosed technology are only presented to describe embodiments whose purpose is to describe the structures and/or functions of the present invention, it should not be concluded that the scope of the rights of the disclosed technology is limited by the embodiments described herein. That is, the embodiments may be modified in various ways and, therefore, it should be understood that the scope of the rights of the disclosed technology may include equivalents which can implement the technical spirit of the present invention. Furthermore, since objects or advantages presented in connection with the disclosed technology do not require that a specific embodiment should fulfill all of them or only one of them, it should not be concluded that the scope of the rights of the disclosed technology is limited by the presented objects and advantages.

Meanwhile, the meanings of terms described herein should be construed as follows:

The terms “first” and “second” are only used to distinguish one element from another element, and the scope of the rights of the disclosed technology should not be limited by these terms. For example, a first element may be designated as a second element, and similarly the second element may be designated as the first element.

When it is described that one element is “connected” or “coupled” to another element, the one element may be directly connected or coupled to another element, but an intervening element may exist therebetween. On the other hand, when it is described that one element is “directly connected” or “directly coupled” to another element, it should be understood that no element exists therebetween. Meanwhile, other expressions which describe the relationships between elements, that is, “between˜” and “directly between ˜” or “adjacent to ˜” and “directly adjacent to ˜,” should be interpreted in the same way.

It should be understood that a singular expression may include a plural expression, as long as the context of the expressions is not obviously different. In this application, the meaning of “include” or “have” are intended to specify a property, a fixed number, a step, a process, an element, a component, and/or a combination thereof but are not intended to exclude the presence or addition of other properties, fixed numbers, steps, processes, elements, components, and/or combinations

Reference characters (for example, a, b, c, etc.) related to steps are used for convenience of description, and are not intended to describe the sequence of the steps. The steps may occur in different sequences, as long as a specific sequence is not specifically described in the context. That is, the steps may occur in a specified sequence, may occur simultaneously, or may be performed in the reverse sequence.

All the terms used herein have the same meanings as terms that are generally understood by those having ordinary knowledge in the art to which the disclosed technology pertains, as long as the terms are defined differently. It should be understood that the terms defined in generally-used dictionaries have meanings coinciding with those of terms in the related technology. As long as the terms are not defined obviously in the present application, they are not ideally or excessively analyzed as having a formal meaning.

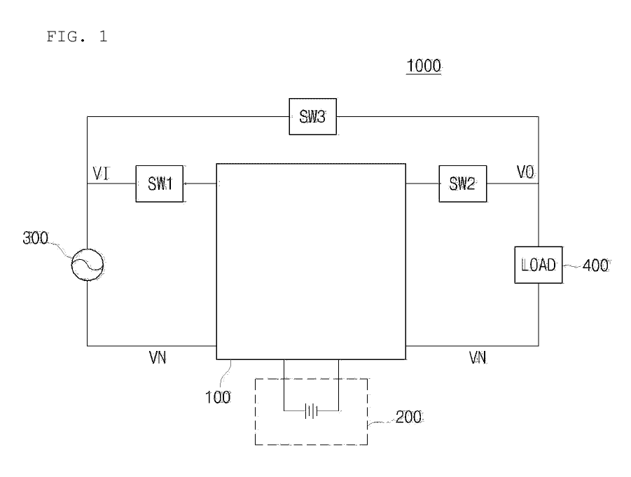

FIG. 1 is a block diagram illustrating an uninterruptible power supply.

Referring to FIG. 1, a switch SW1 is coupled between the uninterruptible power supply (UPS) 100 and an input power 300, and a switch SW2 is coupled between the UPS 100 and a load 400. A bypass switch SW3 is coupled between the input power 300 and the load 400 to directly provide the input power 300 to the load 400 in a maintenance operation of the USP 100. A switch may be implemented by using insulated gated bipolar transistor IGBT.

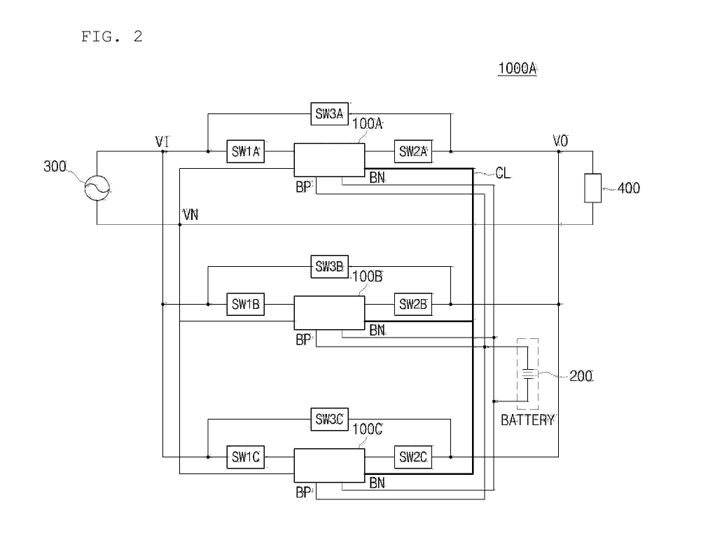

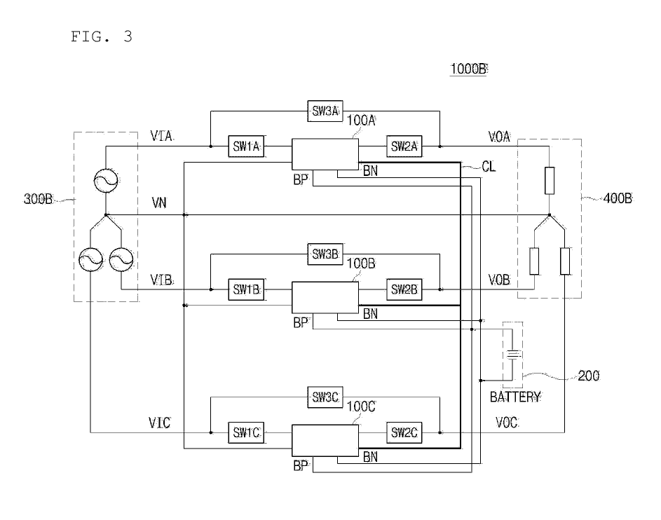

FIGS. 2 and 3 are block diagrams illustrating an uninterruptible power supply system according to an example embodiment of the present invention.

FIG. 2 illustrates a UPS system 1000A when a configuration mode is a single-phase parallel mode.

Referring to FIG. 2, the UPS system 1000A includes a plurality of UPS devices 100A through 100C. Each of the plurality of the UPS devices 100A through 100C is coupled, through switches SW1A through SW1C, SW2A through SW2C and SW3A through SW3C, to a single-phase AC input voltage and a load. Each of the plurality of the UPS devices 100A through 100C provides a single-phase AC input voltage VI to a load 400A and a battery 200 when an operation mode is a normal mode, and transforms power of the battery 200 into a single-phase AC output voltage VO to provide the converted single-phase AC output voltage VO to the load 400A.

In the normal mode, each of the plurality of UPS devices 100A through 100C provides a single-phase AC input voltage VI to the load 400A while charging the battery 200. When power provided through the single-phase AC input voltage VI is interrupted or power flow is unstable due to rapid change of level and phase for the single-phase AC input voltage VI, each of the plurality of UPS devices 100A through 100C operates in a blackout mode. Each of the plurality of UPS devices 100A through 100C transforms power of the charged battery 200 into the single-phase AC output voltage VO to provide the transformed single-phase AC output voltage VO to the load 400A.

The configuration mode of the UPS system 1000A includes a single-phase parallel mode and a three-phase mode. As illustrated in FIG. 2, the plurality of UPS devices 100A through 100C are parallel-coupled when the configuration mode is a single-phase parallel mode. Therefore, each of the plurality of UPS devices 100A through 100C commonly receives the single-phase AC input voltage VI to commonly output the single-phase output voltage VO. The plurality of UPS devices 100A through 100C in parallel may share the battery 200.

FIG. 3 illustrates a UPS system 1000B when a configuration mode is a three phase mode.

Referring to FIG. 3, the UPS system 1000B may be configured with a three-phase mode. Each of the plurality of UPS devices 100A through 100C provides a single-phase AC input voltage VIA, VIB or VIC to a load 400B and the battery 200 according to the operation mode or transforms power of the battery 200 into the single-phase AC output voltage to the transformed single-phase AC output voltage to the load 400B.

In a three-phase mode of the UPS system 1000B, the plurality of UPS devices may include at least three UPS devices 100A through 100C. Each of the at least three UPS devices 100A through 100C independently receives each of three-phase AC input voltage VIA through VIC to output each of three-phase AC output voltage VOA through VOC.

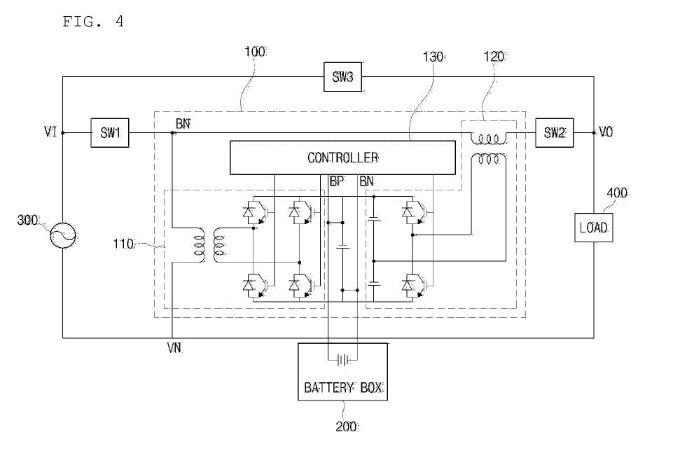

FIG. 4 is a block diagram illustrating a UPS device according to an example embodiment of the present invention.

A UPS device in FIG. 4 indicates one of the plurality of the UPS devices 100A through 100C in FIGS. 2 and 3.

Referring to FIG. 4, the UPS device 100 includes a first transforming circuit 110, a second transforming circuit 120 and a control unit 130.

The first transforming circuit 110 commonly receives a single-phase AC input voltage with a separate single-phase UPS device (not shown) to transmit the received single-phase AC input voltage to the battery when the configuration mode is the single-phase parallel mode. Also, the first transforming circuit 110 receives phase voltage of the three-phase AC input voltage to transmit the received phase voltage to the battery 200 when the configuration mode is the three-phase mode.

The second transforming circuit 120 transforms power of the battery 200 into a single-phase output voltage to commonly output the transformed single-phase AC output voltage with the separate single-phase USP device when the configuration mode is the single-phase parallel mode. Also, the second transforming circuit 120 transforms power of the battery 200 into phase voltage of the three-phase output voltage to output the transformed phase voltage when the configuration mode is the three-phase mode.

The control unit 130 of the UPS device 100 includes a setting unit and a processor. The setting unit sets the configuration mode of the UPS device and a parameter according to the configuration mode and the processor controls the first and second transforming circuits 110 and 120 based on the configuration mode and parameter.

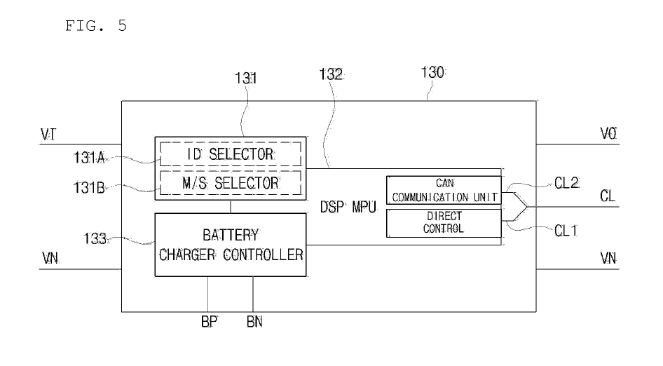

FIG. 5 is a block diagram illustrating a control unit included in an uninterruptible power supply device in FIG. 4.

Referring to FIG. 5, a control unit 130 includes a setting unit 131 and a processor 132.

The setting unit 131 sets the configuration mode of the UPS device and the parameter according to the configuration mode. That is, the setting unit 131 sets whether the UPS device 100 or the USP system 1000A or 1000B is used in the single-phase parallel mode or the three-phase mode. The setting unit 131 may change the configuration mode through user input received from an external panel of the UPS device 100.

The processor 132 controls the first and second transforming circuits 110 and 120 based on the configuration mode and parameter. The processor 132 may correspond to a microprocessor unit for digital signal processing.

The control unit 130 may further include a battery charging control unit 133. The battery charging control unit 133 detects voltage and current of the battery and adjusts battery supply voltage and current based on the detected voltage and current of the battery.

Herein, with references to FIGS. 3 and 5, operation of the UPS system will be described when the configuration mode is a three phase mode.

The setting unit 131 sets the configuration mode of the UPS system 1000B into the three-phase mode by means of user input. When the configuration mode is set as the three-phase mode, the setting unit 131 may additionally set the parameter. The parameter may include identification information for each of the three UPS devices 100A through 100C and master or slave setting information for each of the three UPS devices 100A through 100C. That is, a user may use the setting unit 131 to set identification information identifying the plurality of the UPS devices and may set one of the plurality of the UPS devices 100A as the master UPS device and others 100B and 100C as the slave UPS devices. For this, the setting unit 131 may include identification selection unit 131A and master slave selection unit 131B.

When the configuration mode is the three-phase mode, the control unit 130 in each of at least three UPS devices 100A through 100C traces a change of the level and phase for each of the three-phase AC input voltage VIA through VIC to independently detect abnormal condition and restoration of electrical power. Also, the control unit 130 independently adjusts the level and phase for the three-phase AC output voltage VOA through VOC. In the case where a transforming circuit using a common iron core is used in transformation between input voltage and output voltage, when the level and phase for one phase voltage of the three-phase voltage are rapidly changed, other phase voltages may be influenced to degrade quality of output voltage. In the UPS system 1000B, the UPS devices 100A through 100C are independently separate and each of the UPS devices 100A through 100C may adjust the level and phase of each phase voltage to reduce influences between phase voltages.

The UPS system 1000B transmits or receives power status information through a transmission line CL for adjusting phase synchronization of each phase voltage VOA, VOB and VOC provided from three UPS devices 100A through 100C to a load. The transmission line CL may include at least one direct control line CL1 that directly transmits a part of the power status information (e.g., abnormal condition of input voltage and restoration of electrical power) as the 1-bit logical voltage level and a communication line CL2 that transmits or receives data for Controller Area Network (CAN) communication. The direct control line CL1 may directly transmit a part of the power status information requiring emergency to rapidly control the operation mode of the UPS devices 100A through 100C.

For example, when one of three-phase AC input voltages VIA through VIC abnormally operates, the UPS device 100A detecting the abnormality converts information for the abnormal condition into the 1-bit logical voltage level to transmit the converted information to other UPS devices 100B and 100C. Other power status information may be transmitted through CAN communication between the UPS devices. Therefore, the control unit 130 of the UPS device 100 includes the CAN communication unit that transmits or receives the power status information through CAN.

Herein, it is assumed that one of at least three UPS devices 100A through 100C is set as a master UPS device and others are set as slave UPS devices 100B and 100C, and operation of UPS devices will be described.

In one embodiment, when abnormal condition of the three-phase input voltages VIA through VIC or restoration of electrical power is detected, the control units of the slave UPS devices 100B and 100C transmit the power status information to the master UPS device 100A.

The power status information transmitted by the slave UPS devices 1008 and 100C may include the level and phase for phase voltage of input AC voltage and may further include information whether a specific UPS device normally operates.

The control unit of the master UPS device 100A determines whether operation modes of the at least three UPS devices 100A through 100C change and synchronization time of the operation mode change based on the power status information transmitted by the slave UPS devices 100B and 100C. That is, the master UPS device 100A may determine whether the operation modes are changed based on the power status information transmitted by the master UPS device 100A and timing for changing the operation modes.

When the operation modes of the UPS devices are changed due to a blackout or restoration, a phase difference may be higher and high voltage or high current may be instantaneously generated. Such problem may occur in a neutral line as well as phase voltage lines. In one embodiment, when the operation modes of the UPS devices 100A through 100C are changed, the master UPS device 100A determines phase synchronization time of each phase voltage to reduce rapid phase difference.

In one embodiment, the UPS devices 100A through 100C in the UPS system 1000B may share the battery. For this, the first and second transforming circuits 110 and 120 in each of the UPS devices 100A through 100C may insulate the battery 200 and I/O units of the UPS devices 100A through 100C. That is, the I/O units of the UPS devices 100A through 100C and the battery are induction-coupled by the first and second transforming circuits 110 and 120.

The battery charging control unit 133 in the control unit 130 detects voltage and current of the battery and may adjust battery supply voltage and current according to time based on voltage and current of the detected battery. The battery charging control unit 133 performs regular charge in initial time of charging and performs irregular charge in full charge state.

The described technology has the following advantages. Because this does not mean that a specific example embodiment should include all the following advantages or only the following advantages, the scope of claim should not be limited to the following advantages.

A UPS system and UPS device according to an example embodiment may change a configuration mode into a single-phase parallel mode or three-phase mode through setting by user input, thereby being used in various AC power forms, and may share a battery among a plurality of UPS devices for cost saving and easy maintenance.

A UPS system and UPS device according to an example embodiment may perform independent repair for each phase voltage in a three-phase mode to maintain three-phase voltage balance and improve operation stability of a load.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. An uninterruptible power supply (UPS) system, comprising:
a plurality of UPS devices configured to provide a single-phase AC input voltage to a load and a battery when an operating mode is a normal mode and configured to convert power of the battery into a single-phase AC output voltage to provide the single-phase AC output voltage to the load when the operation mode is a blackout mode,
wherein each of the plurality of the UPS devices commonly receives the single-phase AC input voltage to commonly output the single-phase AC output voltage when a configuration mode is a single-phase parallel mode, and
wherein at least three UPS devices independently receive each of a three-phase AC input voltage to output each of a three-phase AC output voltage when the configuration mode is a three-phase mode.

2. The UPS system of claim 1, wherein each of the plurality of the UPS devices includes a setting unit and a control unit, the setting unit setting the configuration mode and a parameter according to the configuration mode, and the control unit including a processor controlling the operating mode based on the configuration mode and the parameter.

3. The UPS system of claim 2, wherein the control unit independently adjusts level and phase for each of the three-phase AC output voltage according to a change of level and phase for each of the three-phase AC input voltage when the configuration mode is the three-phase mode.

4. The UPS system of claim 3, wherein the parameter includes identification information of each of the plurality of the UPS devices and master or slave setting information.

5. The UPS system of claim 4, wherein the control unit traces the change of the level and phase for the three-phase AC input voltage to detect an abnormal condition and restoration of electrical power.

6. The UPS system of claim 5, wherein control units of slave UPS devices transmit power status information to a master UPS device in the abnormal condition and restoration of electrical power.

7. The UPS system of claim 6, wherein a control unit of the master UPS device determines whether operation modes of the plurality of the UPS devices are changed, and a synchronization time for changing the operation modes based on the power status information.

8. The UPS system of claim 6, wherein the control unit of the master UPS device includes:
a CAN (Controller Area Network) communication unit configured to transmit or receive the power status information through the CAN; and
at least one direct control line configured to convert a part of the power status information into 1-bit logical voltage level to directly transmit the 1-bit logical voltage level to the master or slave UPS devices.

9. The UPS system of claim 6, wherein the control unit of the master UPS device further includes a battery charging control unit configured to detect voltage and current of the battery to adjust a battery supply voltage and current.

10. The UPS system of claim 1, wherein the plurality of the UPS devices share the battery.

11. The UPS system of claim 10, wherein each of the plurality of the UPS devices includes:
a first transforming circuit being induction-coupled to an input unit and the battery, the first transforming circuit configured to transform phase voltage of the single-phase AC input voltage or three-phase AC input voltage into DC power to transmit the transformed phase voltage to the battery; and
a second transforming circuit being induction-coupled to an output unit and the battery, the second transforming circuit configured to transform power of the battery into AC power to the transformed AC power to the output unit.

12. An uninterruptible power supply (UPS) device comprising:
a first transforming circuit configured to commonly receive a single-phase AC input voltage with a separate single-phase UPS device to transmit the received single-phase AC input voltage to a battery when a configuration mode is a single-phase parallel mode and configured to receive a phase voltage of three-phase AC input voltage to transmit the received phase voltage to the battery when the configuration mode is a three-phase mode;
a second transforming circuit configured to transform a power of the battery into a single-phase AC output voltage to commonly output the converted single-phase AC output voltage with the separate single-phase UPS device when the configuration mode is the single-phase parallel mode and configured to transform the power of the battery into a three-phase AC output voltage to output the converted three phase AC output voltage when the configuration mode is the three-phase mode; and
a control unit including a setting unit and a processor, the setting unit setting the configuration mode and a parameter according to the configuration mode, and the processor controlling an operation mode of the first and second transforming circuits based on the configuration mode and the parameter.

13. The UPS device of claim 12, wherein the control unit adjusts level and phase for phase voltage of the three phase AC output voltage according to a change of level and phase for phase voltage of the three phase AC input voltage, independently with the separate single-phase UPS device, when the configuration mode is the three-phase mode.

14. The UPS device of claim 13, wherein the control unit traces the change of the level and phase for each of the three phase AC input voltage to detect an abnormal condition and restoration of electrical power, and transmits power status information to the separate UPS device in the abnormal condition and restoration of electrical power.

15. The UPS device of claim 14, wherein the control unit includes:
a CAN (Controller Area Network) communication unit configured to transmit or receive the power status information through the CAN; and
at least one direct control line configured to convert a part of the power status information into 1-bit logical voltage level to directly transmit the 1-bit logical voltage level to the separate single-phase UPS device.

16. The UPS device of claim 12, wherein the first transforming circuit, the second transforming circuit and the separate single-phase UPS share the battery.
